(19) United States
(12) Patent Application Publication
(10) Pub. No.: US 2026/0247339 A1
(43) Pub. Date: Aug. 20, 2026

(54) AI BASED POSITIONING SOURCE SELECTION FACTOR

(71) Applicant: MEDIATEK INC., Hsinchu (TW)

(72) Inventors: CHIA-SHING TAI, Hsinchu (TW); Shao-Lun Tseng, Hsinchu (TW); YUN-HAO WANG, Hsinchu (TW); Jian-Nong Li, Hsinchu (TW); CHIH-HUNG LEE, Hsinchu (TW)

(21) Appl. No.: 19/055,670

(22) Filed: Feb. 18, 2025

(51) Int. Cl. H04W 64/00; G01S 11/06; H04W 24/02

(52) U.S. Cl. CPC H04W 64/006; G01S 11/06; H04W 24/02

(57) ABSTRACT

In an aspect of the disclosure, a method, a computer-readable medium, and an apparatus are provided. The method involves operation of a user equipment (UE). The UE obtains a current position estimate of the UE determined based on signals received from a global navigation satellite system (GNSS). The UE determines a current movement status of the UE. When the current movement status indicates that the UE is stationary, the current position estimate is fused with a previous position estimate to generate a fused position estimate; and the fused position estimate is outputted as positioning data of the UE.

### BACKGROUND

### Field

The present disclosure relates generally to wireless communications, and more particularly, to techniques of enhancing Global Navigation Satellite System (GNSS) positioning accuracy using artificial intelligence (AI)-based mobility detection and position fusion algorithms.

### Background

The statements in this section merely provide background information related to the present disclosure and may not constitute prior art.

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

Global Navigation Satellite System (GNSS) has been the primary technology for obtaining accurate location information for mobile devices, particularly when other sensors like cameras, gyroscopes, accelerometers, and magnetometers are not available. GNSS positioning works by receiving signals from multiple satellites and using trilateration to determine the device's location. The accuracy of GNSS positioning is typically characterized by an uncertainty value, which represents the statistical dispersion of measured position values and indicates the confidence level of the position estimate.

However, GNSS positioning faces significant challenges in indoor environments and urban areas where buildings and other structures obstruct satellite signals. In these scenarios, GNSS signals are frequently blocked or affected by multipath interference, where signals reflect off structures before reaching the receiving device. These environmental factors cause substantial fluctuations in positioning uncertainty and can result in position estimates that drift or deviate significantly from the actual location. The problem becomes particularly acute when the device has limited sky visibility, such as when only signals from one direction are available.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The method involves operation of a user equipment (UE). The UE obtains a current position estimate of the UE determined based on signals received from a global navigation satellite system (GNSS). The UE determines a current movement status of the UE. When the current movement status indicates that the UE is stationary, the current position estimate is fused with a previous position estimate to generate a fused position estimate; and the fused position estimate is outputted as positioning data of the UE.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2 is a diagram illustrating a base station in communication with a UE in an access network.

FIG. 3 illustrates an example logical architecture of a distributed access network.

FIG. 4 illustrates an example physical architecture of a distributed access network.

FIG. 5 is a diagram showing an example of a DL-centric slot.

FIG. 6 is a diagram showing an example of an UL-centric slot.

FIG. 7 is a diagram illustrating an example wireless communication system including a base station and a UE.

FIG. 8(A) is a diagram illustrating an example global navigation satellite system (GNSS).

FIG. 8(B) is a diagram illustrating an example of GNSS positioning in an urban environment where satellite signals are obstructed by buildings.

FIG. 9 illustrates a flow chart of AI-based UE mobility detection to compensate for GNSS positioning results.

FIG. 10 illustrates a flow chart of a process for positioning the UE.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunications systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example aspects, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

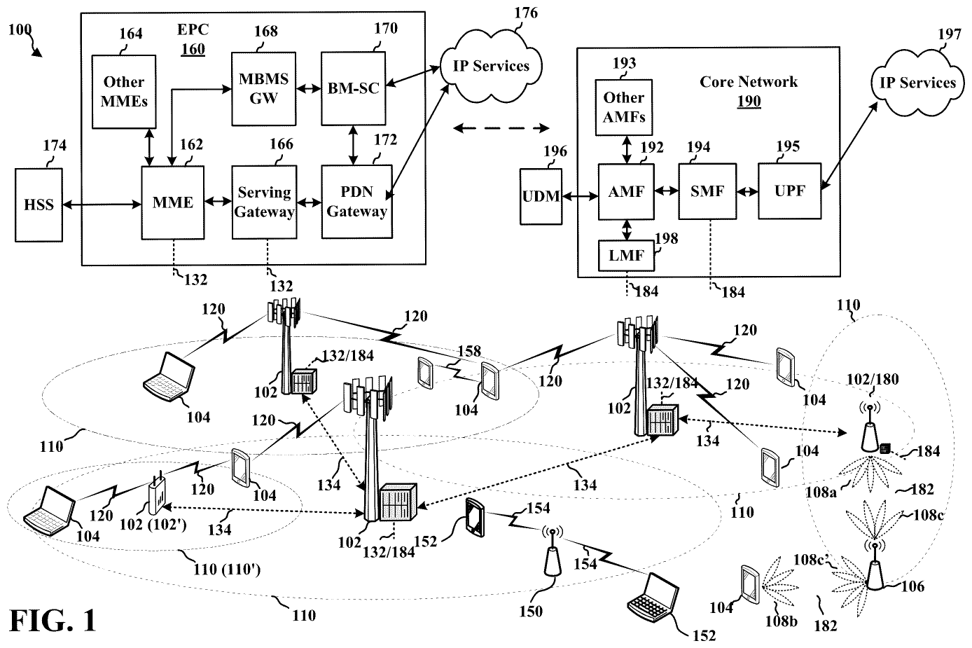

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through backhaul links 132 (e.g., SI interface). The base stations 102 configured for 5G NR (collectively referred to as Next Generation RAN (NG-RAN)) may interface with core network 190 through backhaul links 184. In addition to other functions, the base stations 102 may perform one or more of the following functions: transfer of user data, radio channel ciphering and deciphering, integrity protection, header compression, mobility control functions (e.g., handover, dual connectivity), inter cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over backhaul links 134 (e.g., X2 interface). The backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to 7 MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network.

A base station 102, whether a small cell 102′ or a large cell (e.g., macro base station), may include an eNB, gNodeB (gNB), or another type of base station. Some base stations, such as gNB 180 may operate in a traditional sub 6 GHz spectrum, in millimeter wave (mmW) frequencies, and/or near mmW frequencies in communication with the UE 104. When the gNB 180 operates in mmW or near mmW frequencies, the gNB 180 may be referred to as an mmW base station. Extremely high frequency (EHF) is part of the RF in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band (e.g., 3 GHZ-300 GHz) has extremely high path loss and a short range. The mmW base station 180 may utilize beamforming 182 with the UE 104 to compensate for the extremely high path loss and short range.

The base station 180 may transmit a beamformed signal to the UE 104 in one or more transmit directions 108a. The UE 104 may receive the beamformed signal from the base station 180 in one or more receive directions 108b. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include a Access and Mobility Management Function (AMF) 192, other AMFs 193, a location management function (LMF) 198, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the SMF 194 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a PS Streaming Service, and/or other IP services.

The base station may also be referred to as a gNB, Node B, evolved Node B (eNB), an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Although the present disclosure may reference 5G New Radio (NR), the present disclosure may be applicable to other similar areas, such as LTE, LTE-Advanced (LTE-A), Code Division Multiple Access (CDMA), Global System for Mobile communications (GSM), or other wireless/radio access technologies.

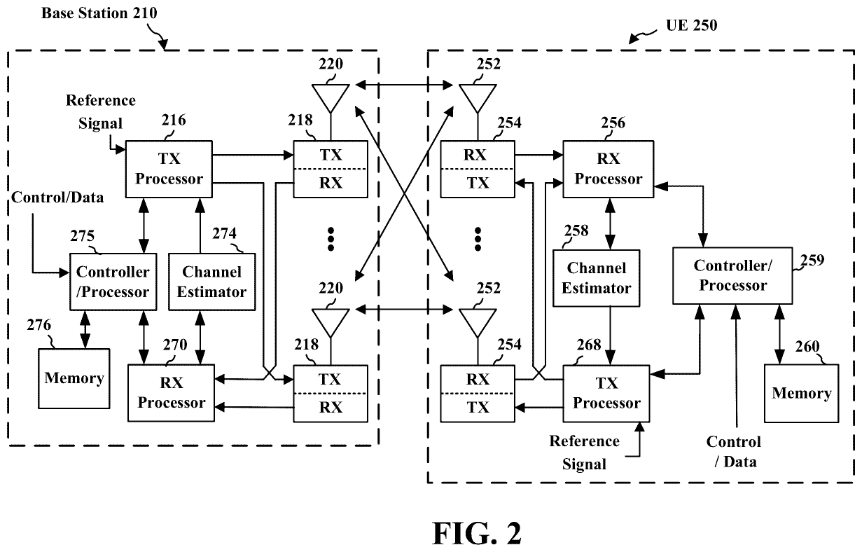

FIG. 2 is a block diagram of a base station 210 in communication with a UE 250 in an access network. In the DL, IP packets from the EPC 160 may be provided to a controller/processor 275. The controller/processor 275 implements layer 3 and layer 2 functionality. Layer 3 includes a radio resource control (RRC) layer, and layer 2 includes a packet data convergence protocol (PDCP) layer, a radio link control (RLC) layer, and a medium access control (MAC) layer. The controller/processor 275 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 216 and the receive (RX) processor 270 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 216 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 274 may be used to determine the coding and modulation scheme, as well as for spatial processing. The channel estimate may be derived from a reference signal and/or channel condition feedback transmitted by the UE 250. Each spatial stream may then be provided to a different antenna 220 via a separate transmitter 218TX. Each transmitter 218TX may modulate an RF carrier with a respective spatial stream for transmission.

At the UE 250, each receiver 254RX receives a signal through its respective antenna 252. Each receiver 254RX recovers information modulated onto an RF carrier and provides the information to the receive (RX) processor 256. The TX processor 268 and the RX processor 256 implement layer 1 functionality associated with various signal processing functions. The RX processor 256 may perform spatial processing on the information to recover any spatial streams destined for the UE 250. If multiple spatial streams are destined for the UE 250, they may be combined by the RX processor 256 into a single OFDM symbol stream. The RX processor 256 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 210. These soft decisions may be based on channel estimates computed by the channel estimator 258. The soft decisions are then decoded and deinterleaved to recover the data and control signals that were originally transmitted by the base station 210 on the physical channel. The data and control signals are then provided to the controller/processor 259, which implements layer 3 and layer 2 functionality.

The controller/processor 259 can be associated with a memory 260 that stores program codes and data. The memory 260 may be referred to as a computer-readable medium. In the UL, the controller/processor 259 provides demultiplexing between transport and logical channels, packet reassembly, deciphering, header decompression, and control signal processing to recover IP packets from the EPC 160. The controller/processor 259 is also responsible for error detection using an ACK and/or NACK protocol to support HARQ operations.

Similar to the functionality described in connection with the DL transmission by the base station 210, the controller/processor 259 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 258 from a reference signal or feedback transmitted by the base station 210 may be used by the TX processor 268 to select the appropriate coding and modulation schemes, and to facilitate spatial processing. The spatial streams generated by the TX processor 268 may be provided to different antenna 252 via separate transmitters 254TX. Each transmitter 254TX may modulate an RF carrier with a respective spatial stream for transmission. The UL transmission is processed at the base station 210 in a manner similar to that described in connection with the receiver function at the UE 250. Each receiver 218RX receives a signal through its respective antenna 220. Each receiver 218RX recovers information modulated onto an RF carrier and provides the information to a RX processor 270.

The controller/processor 275 can be associated with a memory 276 that stores program codes and data. The memory 276 may be referred to as a computer-readable medium. In the UL, the controller/processor 275 provides demultiplexing between transport and logical channels, packet reassembly, deciphering, header decompression, control signal processing to recover IP packets from the UE 250. IP packets from the controller/processor 275 may be provided to the EPC 160. The controller/processor 275 is also responsible for error detection using an ACK and/or NACK protocol to support HARQ operations.

New radio (NR) may refer to radios configured to operate according to a new air interface (e.g., other than Orthogonal Frequency Divisional Multiple Access (OFDMA)-based air interfaces) or fixed transport layer (e.g., other than Internet Protocol (IP)). NR may utilize OFDM with a cyclic prefix (CP) on the uplink and downlink and may include support for half-duplex operation using time division duplexing (TDD). NR may include Enhanced Mobile Broadband (eMBB) service targeting wide bandwidth (e.g. 80 MHz beyond), millimeter wave (mmW) targeting high carrier frequency (e.g. 60 GHz), massive MTC (mMTC) targeting non-backward compatible MTC techniques, and/or mission critical targeting ultra-reliable low latency communications (URLLC) service.

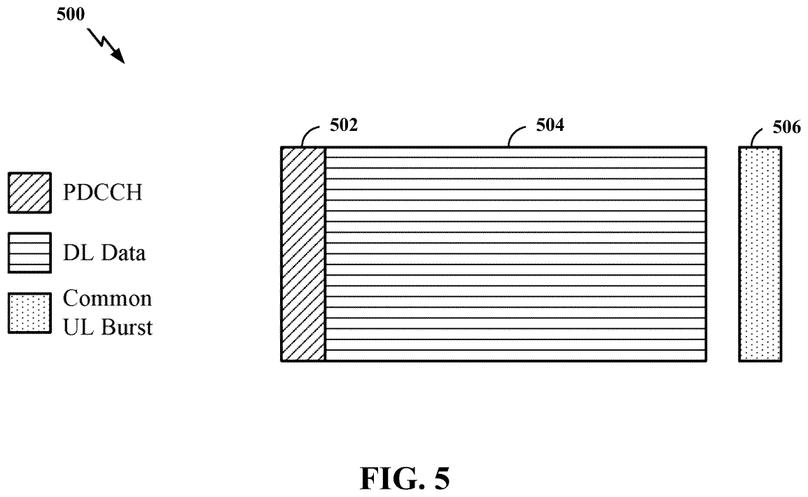

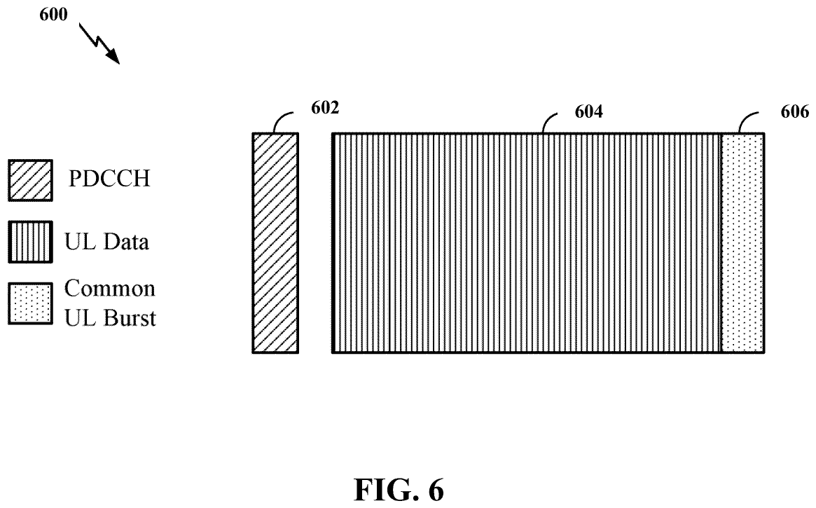

A single component carrier bandwidth of 100 MHz may be supported. In one example, NR resource blocks (RBs) may span 12 sub-carriers with a sub-carrier bandwidth of 60 kHz over a 0.25 ms duration or a bandwidth of 30 kHz over a 0.5 ms duration (similarly, 50 MHz BW for 15 kHz SCS over a 1 ms duration). Each radio frame may consist of 10 subframes (10, 20, 40 or 80 NR slots) with a length of 10 ms. Each slot may indicate a link direction (i.e., DL or UL) for data transmission and the link direction for each slot may be dynamically switched. Each slot may include DL/UL data as well as DL/UL control data. UL and DL slots for NR may be as described in more detail below with respect to FIGS. 5 and 6.

The NR RAN may include a central unit (CU) and distributed units (DUs). A NR BS (e.g., gNB, 5G Node B, Node B, transmission reception point (TRP), access point (AP)) may correspond to one or multiple BSs. NR cells can be configured as access cells (ACells) or data only cells (DCells). For example, the RAN (e.g., a central unit or distributed unit) can configure the cells. DCells may be cells used for carrier aggregation or dual connectivity and may not be used for initial access, cell selection/reselection, or handover. In some cases DCells may not transmit synchronization signals (SS) in some cases DCells may transmit SS. NR BSs may transmit downlink signals to UEs indicating the cell type. Based on the cell type indication, the UE may communicate with the NR BS. For example, the UE may determine NR BSs to consider for cell selection, access, handover, and/or measurement based on the indicated cell type.

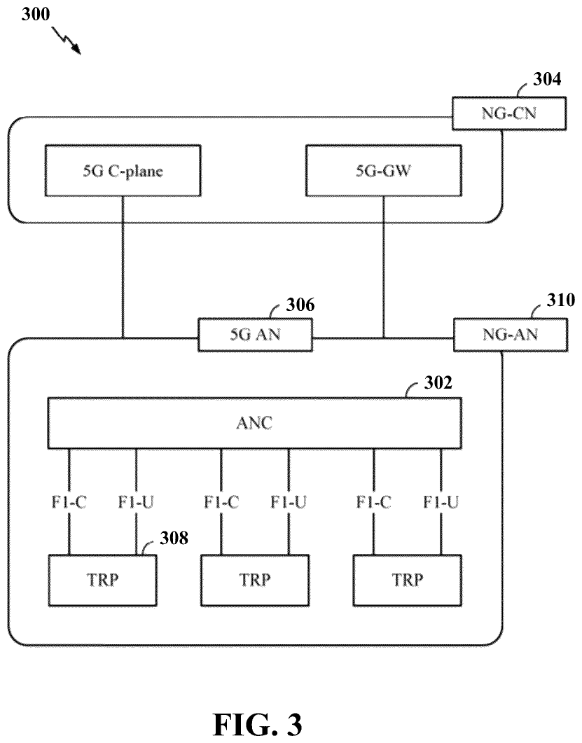

FIG. 3 illustrates an example logical architecture of a distributed RAN 300, according to aspects of the present disclosure. A 5G access node 306 may include an access node controller (ANC) 302. The ANC may be a central unit (CU) of the distributed RAN. The backhaul interface to the next generation core network (NG-CN) 304 may terminate at the ANC. The backhaul interface to neighboring next generation access nodes (NG-ANs) 310 may terminate at the ANC. The ANC may include one or more TRPs 308 (which may also be referred to as BSs, NR BSs, Node Bs, 5G NBs, APs, or some other term). As described above, a TRP may be used interchangeably with “cell.”

The TRPs 308 may be a distributed unit (DU). The TRPs may be connected to one ANC (ANC 302) or more than one ANC (not illustrated). For example, for RAN sharing, radio as a service (RaaS), and service specific ANC deployments, the TRP may be connected to more than one ANC. A TRP may include one or more antenna ports. The TRPs may be configured to individually (e.g., dynamic selection) or jointly (e.g., joint transmission) serve traffic to a UE.

The local architecture of the distributed RAN 300 may be used to illustrate fronthaul definition. The architecture may be defined that support fronthauling solutions across different deployment types. For example, the architecture may be based on transmit network capabilities (e.g., bandwidth, latency, and/or jitter). The architecture may share features and/or components with LTE. According to aspects, the next generation AN (NG-AN) 310 may support dual connectivity with NR. The NG-AN may share a common fronthaul for LTE and NR.

The architecture may enable cooperation between and among TRPs 308. For example, cooperation may be preset within a TRP and/or across TRPs via the ANC 302. According to aspects, no inter-TRP interface may be needed/present.

According to aspects, a dynamic configuration of split logical functions may be present within the architecture of the distributed RAN 300. The PDCP, RLC, MAC protocol may be adaptably placed at the ANC or TRP.

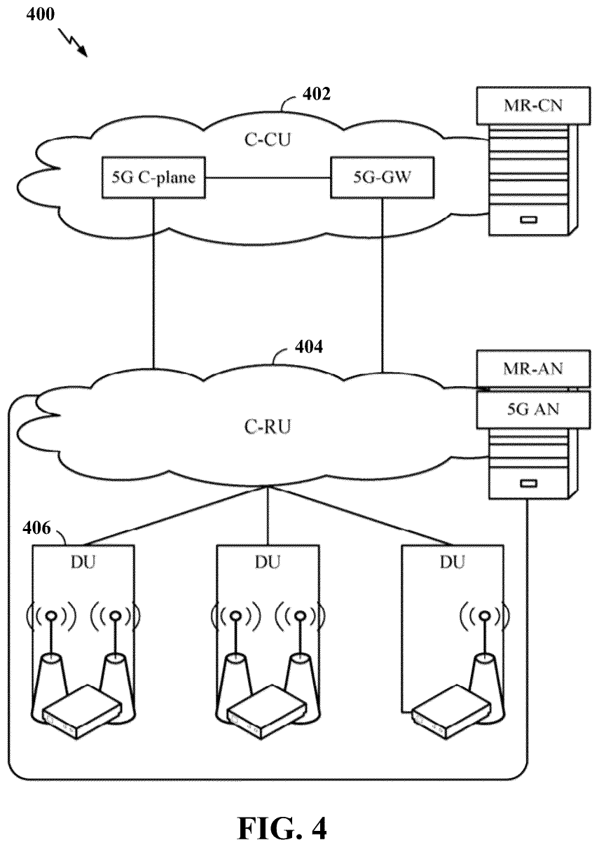

FIG. 4 illustrates an example physical architecture of a distributed RAN 400, according to aspects of the present disclosure. A centralized core network unit (C-CU) 402 may host core network functions. The C-CU may be centrally deployed. C-CU functionality may be offloaded (e.g., to advanced wireless services (AWS)), in an effort to handle peak capacity. A centralized RAN unit (C-RU) 404 may host one or more ANC functions. Optionally, the C-RU may host core network functions locally. The C-RU may have distributed deployment. The C-RU may be closer to the network edge. A distributed unit (DU) 406 may host one or more TRPs. The DU may be located at edges of the network with radio frequency (RF) functionality.

FIG. 5 is a diagram 500 showing an example of a DL-centric slot. The DL-centric slot may include a control portion 502. The control portion 502 may exist in the initial or beginning portion of the DL-centric slot. The control portion 502 may include various scheduling information and/or control information corresponding to various portions of the DL-centric slot. In some configurations, the control portion 502 may be a physical DL control channel (PDCCH), as indicated in FIG. 5. The DL-centric slot may also include a DL data portion 504. The DL data portion 504 may sometimes be referred to as the payload of the DL-centric slot. The DL data portion 504 may include the communication resources utilized to communicate DL data from the scheduling entity (e.g., UE or BS) to the subordinate entity (e.g., UE). In some configurations, the DL data portion 504 may be a physical DL shared channel (PDSCH).

The DL-centric slot may also include a common UL portion 506. The common UL portion 506 may sometimes be referred to as an UL burst, a common UL burst, and/or various other suitable terms. The common UL portion 506 may include feedback information corresponding to various other portions of the DL-centric slot. For example, the common UL portion 506 may include feedback information corresponding to the control portion 502. Non-limiting examples of feedback information may include an ACK signal, a NACK signal, a HARQ indicator, and/or various other suitable types of information. The common UL portion 506 may include additional or alternative information, such as information pertaining to random access channel (RACH) procedures, scheduling requests (SRs), and various other suitable types of information.

As illustrated in FIG. 5, the end of the DL data portion 504 may be separated in time from the beginning of the common UL portion 506. This time separation may sometimes be referred to as a gap, a guard period, a guard interval, and/or various other suitable terms. This separation provides time for the switch-over from DL communication (e.g., reception operation by the subordinate entity (e.g., UE)) to UL communication (e.g., transmission by the subordinate entity (e.g., UE)). One of ordinary skill in the art will understand that the foregoing is merely one example of a DL-centric slot and alternative structures having similar features may exist without necessarily deviating from the aspects described herein.

FIG. 6 is a diagram 600 showing an example of an UL-centric slot. The UL-centric slot may include a control portion 602. The control portion 602 may exist in the initial or beginning portion of the UL-centric slot. The control portion 602 in FIG. 6 may be similar to the control portion 502 described above with reference to FIG. 5. The UL-centric slot may also include an UL data portion 604. The UL data portion 604 may sometimes be referred to as the pay load of the UL-centric slot. The UL portion may refer to the communication resources utilized to communicate UL data from the subordinate entity (e.g., UE) to the scheduling entity (e.g., UE or BS). In some configurations, the control portion 602 may be a physical DL control channel (PDCCH).

As illustrated in FIG. 6, the end of the control portion 602 may be separated in time from the beginning of the UL data portion 604. This time separation may sometimes be referred to as a gap, guard period, guard interval, and/or various other suitable terms. This separation provides time for the switch-over from DL communication (e.g., reception operation by the scheduling entity) to UL communication (e.g., transmission by the scheduling entity). The UL-centric slot may also include a common UL portion 606. The common UL portion 606 in FIG. 6 may be similar to the common UL portion 506 described above with reference to FIG. 5. The common UL portion 606 may additionally or alternatively include information pertaining to channel quality indicator (CQI), sounding reference signals (SRSs), and various other suitable types of information. One of ordinary skill in the art will understand that the foregoing is merely one example of an UL-centric slot and alternative structures having similar features may exist without necessarily deviating from the aspects described herein.

In some circumstances, two or more subordinate entities (e.g., UEs) may communicate with each other using sidelink signals. Real-world applications of such sidelink communications may include public safety, proximity services, UE-to-network relaying, vehicle-to-vehicle (V2V) communications, Internet of Everything (IoE) communications, IoT communications, mission-critical mesh, and/or various other suitable applications. Generally, a sidelink signal may refer to a signal communicated from one subordinate entity (e.g., UE1) to another subordinate entity (e.g., UE2) without relaying that communication through the scheduling entity (e.g., UE or BS), even though the scheduling entity may be utilized for scheduling and/or control purposes. In some examples, the sidelink signals may be communicated using a licensed spectrum (unlike wireless local area networks, which typically use an unlicensed spectrum).

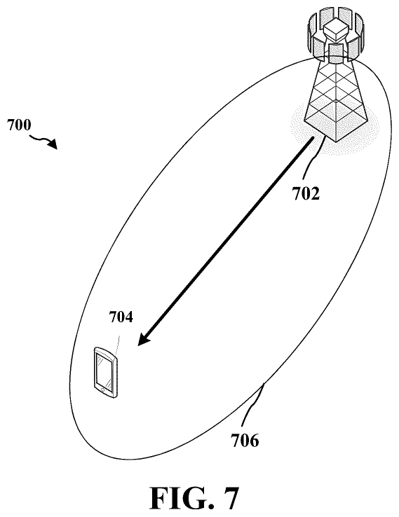

FIG. 7 is a diagram 700 illustrating an example wireless communication system including a base station and a UE. In this example, a UE 704 is connected to a base station 702 on a cell 706.

In a wireless communication system such as the one shown in FIG. 7, accurate positioning of a UE 704 connected to a base station 702 on a cell 706 may be necessary. The Global Navigation Satellite System (GNSS) serves as the primary location provider source for obtaining accurate location information for the UE 704 when other sensors are not available. These sensors may include cameras, gyroscopes, accelerometers, magnetometers, and similar devices that can assist in relative position determination.

The accuracy of GNSS positioning can be characterized by an uncertainty value, which represents the statistical dispersion of the measured position values. This uncertainty manifests visually in applications like Google Maps as a blue circle surrounding the position marker, where the circle's radius indicates the error of the position estimate. A larger uncertainty value corresponds to lower confidence in the GNSS positioning results, while a smaller uncertainty value indicates higher confidence.

However, GNSS positioning faces significant challenges in indoor environments and urban areas. In these scenarios, GNSS signals are frequently obscured by buildings or affected by multipath interference, where signals reflect off structures before reaching the UE 704. These environmental factors cause substantial fluctuations in positioning uncertainty and can result in position estimates that drift or deviate significantly from the actual location. For example, when a user remains stationary near a building, the reported position may appear to move erratically due to signal interference, leading to a degraded user experience.

The positioning accuracy becomes particularly problematic when the UE 704 has limited sky visibility, such as when only signals from one direction are available. In urban environments, this often occurs when buildings block signals from certain directions, resulting in an uneven distribution of available satellites for positioning calculations. This uneven distribution can cause systematic bias in the position estimates, typically pulling the calculated position toward the direction with better satellite visibility.

To address these challenges, an AI-based approach can be implemented to enhance positioning accuracy, particularly in static scenarios. This approach uses AI models to detect the mobility state of the UE 704 and applies appropriate positioning algorithms based on this information. When the UE 704 is determined to be stationary, historical positioning data can be utilized to improve accuracy and reduce position fluctuations, leading to more stable and reliable location information.

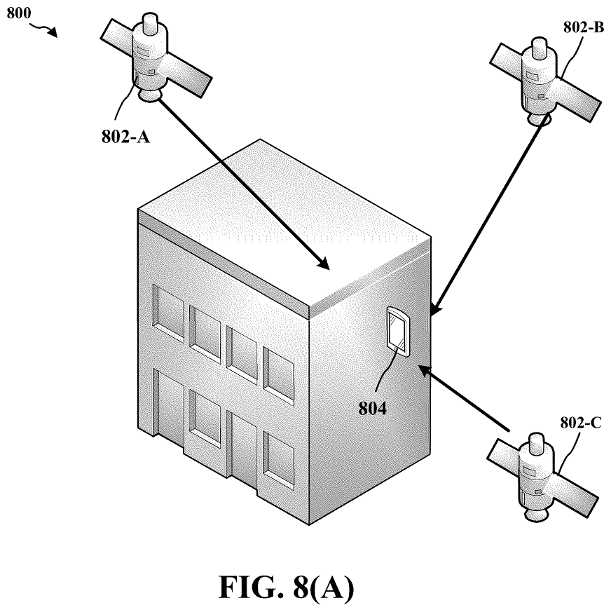

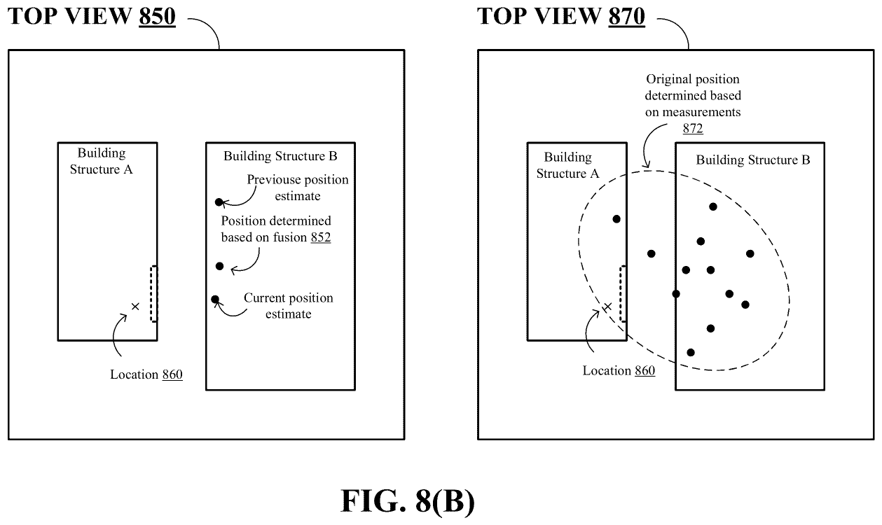

FIG. 8(A) is a diagram 800 illustrating an example of a Global Navigation Satellite System (GNSS) positioning scenario. A UE, such as the UE 804, may determine its position using signals from satellites such as satellites 802-A, 802-B, 802-C.

In GNSS positioning, uncertainty is a statistical indicator that expresses the dispersion of values attributed to a measured quantity. It serves as a measure to assess the adequacy of a positioning estimate, akin to a confidence level. In the context of GNSS, uncertainty describes the estimated location accuracy, where a higher uncertainty value implies lower confidence in the positioning results, and a lower uncertainty value implies higher confidence.

In environments such as indoor spaces or urban areas with dense buildings, GNSS signals are often obscured or reflected due to obstructions and multipath effects. These phenomena lead to deviations or drifts in the positioning points, causing drastic fluctuations in the uncertainty of the positioning results and significantly reducing the user experience.

To address these challenges, an AI-based mobility detection approach can be employed to enhance positioning accuracy. This approach assesses the environment and the UE's mobility status as factors in selecting a positioning source to obtain the optimal positioning result, especially when the UE is stationary. Based on the mobility information, it is determined whether a historical optimal positioning point can be adopted as the current positioning point at that moment in time.

If it is determined that a UE, such as the UE 804, is stationary, the historical position with minimal uncertainty can serve as a reliable source. This position may consistently be used as the positioning result. It is important to note that even though this position is considered optimal, it may still have slight discrepancies from the actual ground truth due to inherent limitations of GNSS signals and environmental factors.

Referring back to FIG. 8, GNSS positioning relies on trilateration using signals from multiple satellites. When the satellites, such as satellites 802-A, 802-B, 802-C, are evenly distributed around the UE 804, the accuracy of the positioning result tends to improve due to balanced geometric dilution of precision (GDOP). However, if the visible sky is limited—for example, when buildings obstruct satellites on one side—the positioning result will naturally be biased toward the direction with better satellite visibility, leading to less accurate positioning.

The present disclosure proposes an approach to compensate for GNSS positioning errors by utilizing AI-based UE mobility detection. An AI model, specifically a neural network (NN)-based AI model, can determine the current movement status of the UE 804, identifying whether it is stationary, moving at walking speed, driving speed, or in a high-speed motion state.

Based on the mobility information provided by the AI model, adjustments can be made to the positioning algorithms through a fusion localization approach that incorporates UE mobility information. The steps involved in this approach include:

The first step involves continuous collection of base station signal measurements. For example, the UE 804 continuously collects necessary signal parameters required for AI inference and positioning algorithms. These parameters include various measurements from the serving cell and neighboring cells, such as:
Reference Signal Received Power (RSRP), Reference Signal Received Quality (RSRQ), Signal-to-Interference-plus-Noise Ratio (SINR), and Received Signal Strength Indicator (RSSI) from different receive antennas;
Serving cell change times within a certain period;
Full band power scan results and frequency RSSI sniffer results.
Time advance measurements; and/or
Other measurement values obtainable from the modem.

These measurements provide detailed insight into the UE's interaction with the network and its environment, serving as inputs for the mobility detection AI model. The second step involves determination of UE movement status through the AI model. The collected measurements are fed into the neural network-based AI model, which processes the inputs to determine the current movement status of the UE 804. The AI model outputs the mobility state, categorizing the UE's movement into classes such as stationary, walking, driving, or high-speed motion. Detecting the UE mobility using only modem measurement information is challenging due to factors such as:
Difficulty in estimating mobility when the UE moves along the tangent direction using traditional methods like the Doppler effect formula.
Complexity in modeling multipath effects in dense urban environments.
Limited measurement data availability when the UE is under no service conditions.

By employing machine learning techniques, particularly a neural network-based AI model, these challenges can be mitigated, enabling accurate prediction of the UE's mobility from the measurement information.

FIG. 8(B) is a diagram illustrating an example of GNSS positioning in an urban environment where satellite signals are obstructed by buildings. The figure comprises two top-down views: TOP VIEW 850 and TOP VIEW 870, representing the positioning results using the proposed fusion algorithm and conventional GNSS measurements, respectively.

In TOP VIEW 850, the UE 804 is located within Building Structure A, near a window. Due to the surrounding buildings, the UE 804 has limited visibility of the sky, causing significant challenges for accurate GNSS positioning. The position 852, determined using the fusion algorithm, is marked near Building Structure A, showing an improved estimation of the UE's actual location.

In contrast, TOP VIEW 870 illustrates multiple GNSS position measurements 872 obtained over time using conventional GNSS positioning without the proposed enhancements. These measurements are scattered predominantly toward the right side, near Building Structure B, indicating a systematic bias in the positioning results. This bias arises from the limited satellite visibility caused by the obstruction of buildings, leading to an uneven distribution of satellites used in the position calculations.

The actual location of the UE 804 is marked with an “X” in both diagrams, representing the ground truth position. In TOP VIEW 870, the scattered GNSS measurements deviate significantly from this true position due to signal obstruction and multipath interference, resulting in an average position error of approximately 76 meters. In comparison, the fusion-based positioning shown in TOP VIEW 850 achieves a reduced average position error of about 47 meters, demonstrating the effectiveness of the proposed method.

The proposed fusion algorithm enhances positioning accuracy by combining historical and current GNSS measurements, particularly when the UE 804 is stationary. The algorithm utilizes AI-based UE mobility detection to determine the movement status of the UE 804 and applies the appropriate positioning strategy accordingly.

When the UE 804 is determined to be stationary, the fusion algorithm integrates the previous position estimate Pₜ₋₁ with the current GNSS position measurement Pₜ to compute a weighted position estimate Pₜ′. The fusion algorithm is defined by the equation:

$${P}_{t}^{′} = {F}_{fused} ( β , α , {P}_{t - 1} , {P}_{t} ) = {P}_{t - 1} \times σ ( β \times α ) + {P}_{t} \times [ 1 - σ ( β \times α ) ] ,$$

Pₜ′ is the fused position estimate at time t. Pₜ₋₁ is a previous position estimate selected based on minimal uncertainty. Pₜ is the current GNSS position measurement. β is the uncertainty value associated with the current GNSS measurement, provided by the GNSS receiver in the UE 804. α is a time factor that accounts for the temporal relevance of the previous position estimate. σ is the sigmoid function defined as

$$σ ( x ) = \frac{1}{1 + {e}^{- x}} .$$

The uncertainty value β reflects the confidence level of the GNSS positioning measurement. It is determined by the GNSS receiver based on factors such as signal quality and satellite geometry. A higher β indicates greater uncertainty in the measurement. This value correlates with the radius of the uncertainty circle often displayed around position markers in mapping applications.

The time factor α adjusts the influence of the previous position estimate based on the time elapsed since it was obtained. If the previous position estimate Pₜ₋₁ is recent, a is larger, giving more weight to Pₜ₋₁ in the fusion. Conversely, if Pₜ₋₁ is from a significantly earlier time, a decreases, reducing its influence. This mechanism prevents the system from relying indefinitely on outdated position estimates.

The sigmoid function σ(β×α) maps the product of the uncertainty and time factors into a value between 0 and 1, serving as a dynamic weighting coefficient in the fusion process. This function ensures that higher uncertainty and older measurements have less influence on the fused position Pₜ′.

In the fusion algorithm, Pₜ₋₁ may not necessarily be the position estimate from the immediate previous time point. Instead, it can be the optimal previous position selected from a set of historical position estimates based on minimal uncertainty and relevance. For instance, among all prior position estimates up to time t-1, the system selects the one deemed most reliable as Pₜ₋₁.

By applying this fusion algorithm, the system mitigates the effects of GNSS measurement errors caused by environmental factors. The fusion process converges the position estimate towards a stable point that closely represents the true location of the UE 804, as seen in TOP VIEW 850.

When the UE 804 is moving, as determined by the AI-based mobility detection, the system defaults to using the latest GNSS position measurement Pₜ without fusion. This approach allows the positioning system to respond promptly to actual movements of the UE 804, ensuring timely updates to its position.

At the initial time point t=0, there is no previous position estimate available. In this case, the system uses the initial GNSS position measurement as the position estimate, i.e., P₀′=P₀.

The UE 804 collects various measurements to determine its mobility status, including Reference Signal Received Power (RSRP), Reference Signal Received Quality (RSRQ), Signal-to-Interference-plus-Noise Ratio (SINR), Received Signal Strength Indicator (RSSI), serving cell change times, and other data available from the modem. These measurements are input into a neural network-based AI model, which classifies the UE's movement status into categories such as stationary, walking speed, driving speed, or high-speed motion.

Detecting UE mobility using only modem measurement information presents challenges due to factors like the complexity of multipath effects in urban environments and limited data when the UE is not in service. Traditional methods, such as relying solely on Doppler effect estimations, may not accurately capture mobility, especially when the UE moves tangentially relative to the signal sources. The use of machine learning techniques allows for more accurate mobility detection by learning patterns from the measurement data.

The incorporation of AI-based mobility detection with the fusion algorithm significantly enhances GNSS positioning accuracy in challenging environments. In scenarios where satellite signals are obstructed, and conventional GNSS positioning suffers from large errors, the proposed method provides a more reliable and stable positioning solution. This improvement is evident in FIG. 8(B), where the fusion-based positioning results in a more accurate estimation of the UE's location compared to the conventional method.

As described supra, when the UE 804 is determined to be stationary, rather than simply using the immediately preceding position estimate, the algorithm can select an optimal historical position from multiple previous measurements. For instance, if there are 100 previous position estimates, the algorithm evaluates these estimates and selects the most reliable one as Pₜ₋₁ based on uncertainty values.

The time factor α weights historical position estimates. When a selected historical position estimate is more recent, it receives a higher α value, indicating greater reliability. Conversely, if the selected position estimate is from a more distant time point, the a value decreases, reducing its influence on the final fused position. For example, if the algorithm is processing the 1000th position estimate and considering using a position estimate from the first measurement, the a value would be adjusted to give less weight to this older measurement, even if it had favorable uncertainty characteristics.

The UE 804 may contain pre-configured algorithms or lookup tables, established during manufacturing, that determine appropriate a values based on the temporal distance between the current time point and the selected historical position estimate.

In practical implementation, when the UE 804 is near Building Structure A with limited satellite visibility, the fusion algorithm can significantly improve positioning accuracy. For example, if position estimate number 50 out of 100 previous measurements shows minimal uncertainty, the algorithm may select this as Pₜ₋₁. However, if a more recent measurement (such as number 999 out of 1000) shows similar positioning quality, the time factor α may favor the more recent measurement, leading to its selection as Pₜ₋₁ in the fusion calculation.

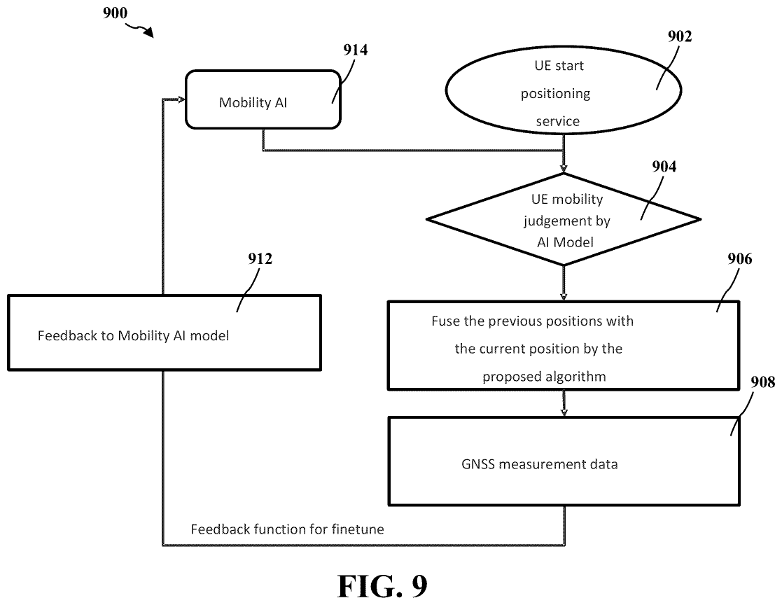

FIG. 9 is a flow chart 900 illustrating an AI-based positioning system with feedback capabilities. The flow chart depicts a process that begins when a UE starts its positioning service in operation 902. The process employs AI-based mobility detection to enhance GNSS positioning accuracy through a combination of real-time processing and continuous system improvement.

Upon initiation of the positioning service in operation 902, the system activates a mobility AI module 914 that determines the UE's movement status. In operation 904, this mobility assessment is performed through an AI model that analyzes whether the UE is stationary or in motion. The AI model processes various input parameters including RSRP, RSRQ, SINR, RSSI, and other modem measurements to make this determination.

When the mobility status is determined, the system proceeds to operation 906, where it implements a fusion algorithm. This algorithm combines historical position data with current GNSS measurements according to the equation:

$${P}_{t}^{′} = {F}_{fused} ( β , α , {P}_{t - 1} , {P}_{t} ) = {P}_{t - 1} \times σ ( β \times α ) + {P}_{t} \times [ 1 - σ ( β \times α ) ] ,$$

The fusion process is particularly active when the UE is determined to be stationary. The algorithm selects optimal historical positions based on uncertainty values and temporal relevance, applying appropriate weighting through the time factor α and uncertainty parameter B.

In operation 908, the system outputs the GNSS measurement data, providing the processed location information to applications or services requiring the UE's position. This output represents the enhanced positioning result that has been refined through the AI-based mobility detection and fusion algorithm.

A feedback mechanism is implemented through operation 912. This feedback loop collects positioning results and UE mobility status information, which is then fed back to the mobility AI module 914. Through this feedback path, the system supports continuous improvement through online training.

The feedback mechanism enables unsupervised training and tuning of the AI model. The system takes the positioning outcomes and mobility determinations from previous iterations and uses them to refine the AI model's parameters. This online learning approach allows the system to adapt to changing environmental conditions and improve its mobility detection accuracy over time.

This process operates continuously while the positioning service is active. The feedback loop creates a self-improving system where each iteration potentially enhances the accuracy of both the mobility detection and the final positioning results. This dynamic adaptation is particularly valuable in challenging environments such as indoor spaces or urban areas where GNSS signals may be compromised by obstructions or multipath effects.

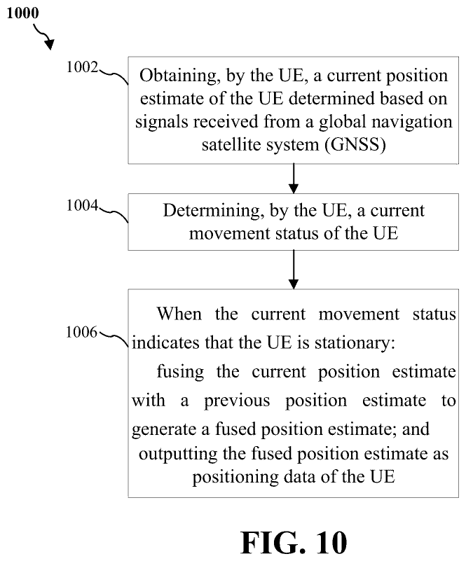

FIG. 10 illustrates a flow chart 1000 of a process for positioning the UE. The process involves operation of a user equipment (UE) (e.g., the UE 704). In operation 1002, the UE obtains a current position estimate of the UE determined based on signals received from a global navigation satellite system (GNSS). Subsequently, in operation 1004, the UE determines, a current movement status of the UE. Next, in operation 1006, when the current movement status indicates that the UE is stationary, the current position estimate is fused with a previous position estimate to generate a fused position estimate; and the fused position estimate is outputted as positioning data of the UE.

In certain configurations, determining the current movement status of the UE may include: collecting, by the UE, base station signal measurements; and processing the base station signal measurements using an artificial intelligence (AI) model to determine the current movement status. In certain configurations, the AI model may include a neural network.

In certain configurations, the base station signal measurements may include at least one of: reference signal received power (RSRP); reference signal received quality (RSRQ); signal-to-interference-plus-noise ratio (SINR); received signal strength indicator (RSSI); serving cell change times; frequency scan results; and time advance measurements.

In certain configurations, the process may further include: feeding back the positioning data to the AI model to fine-tune the AI model.

In certain configurations, fusing the current position estimate with the previous position estimate may include: computing a fusion weight based on a sigmoid function evaluated at a product of an uncertainty value associated with the current position estimate and a time factor associated with the previous position estimate; and combining the previous position estimate weighted by the fusion weight with the current position estimate weighted by a complement of the fusion weight.

In certain configurations, the time factor may have a greater value when a time point corresponding to the previous position estimate is closer to a current time point.

In certain configurations, when the current movement status indicates that the UE is moving, the process may include: outputting the current position estimate as the positioning data of the UE.

In certain configurations, the previous position estimate may be selected as an optimal historical position estimate from a set of historical position estimates based on uncertainty values and temporal relevance.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method of operation of a user equipment (UE), comprising:
obtaining, by the UE, a current position estimate of the UE determined based on signals received from a global navigation satellite system (GNSS);
determining, by the UE, a current movement status of the UE; and
when the current movement status indicates that the UE is stationary:
fusing the current position estimate with a previous position estimate to generate a fused position estimate; and
outputting the fused position estimate as positioning data of the UE.

2. The method of claim 1, wherein determining the current movement status of the UE comprises:
collecting, by the UE, base station signal measurements; and
processing the base station signal measurements using an artificial intelligence (AI) model to determine the current movement status.

3. The method of claim 2, wherein the AI model comprises a neural network.

4. The method of claim 2, wherein the base station signal measurements comprise at least one of:
reference signal received power (RSRP);
reference signal received quality (RSRQ);
signal-to-interference-plus-noise ratio (SINR);
received signal strength indicator (RSSI);
serving cell change times;
frequency scan results; and
time advance measurements.

5. The method of claim 2, further comprising:
feeding back the positioning data to the AI model to fine-tune the AI model.

6. The method of claim 1, wherein fusing the current position estimate with the previous position estimate comprises:
computing a fusion weight based on a sigmoid function evaluated at a product of an uncertainty value associated with the current position estimate and a time factor associated with the previous position estimate; and
combining the previous position estimate weighted by the fusion weight with the current position estimate weighted by a complement of the fusion weight.

7. The method of claim 6, wherein the time factor has a greater value when a time point corresponding to the previous position estimate is closer to a current time point.

8. The method of claim 1, wherein when the current movement status indicates that the UE is moving, the method comprises:
outputting the current position estimate as the positioning data of the UE.

9. The method of claim 1, wherein the previous position estimate is selected as an optimal historical position estimate from a set of historical position estimates based on uncertainty values and temporal relevance.

10. An apparatus for operation of a user equipment (UE), comprising:
a memory; and
at least one processor coupled to the memory and configured to:
obtain, through the UE, a current position estimate of the UE determined based on signals received from a global navigation satellite system (GNSS);
determine, through the UE, a current movement status of the UE; and
when the current movement status indicates that the UE is stationary:
fuse the current position estimate with a previous position estimate to generate a fused position estimate; and
output the fused position estimate as positioning data of the UE.

11. The apparatus of claim 10, wherein determining the current movement status of the UE comprises:
collecting, by the UE, base station signal measurements; and
processing the base station signal measurements using an artificial intelligence (AI) model to determine the current movement status.

12. The apparatus of claim 11, wherein the AI model comprises a neural network.

13. The apparatus of claim 11, wherein the base station signal measurements comprise at least one of:
reference signal received power (RSRP);
reference signal received quality (RSRQ);
signal-to-interference-plus-noise ratio (SINR);
received signal strength indicator (RSSI);
serving cell change times;
frequency scan results; and
time advance measurements.

14. The apparatus of claim 11, further comprising:
feeding back the positioning data to the AI model to fine-tune the AI model.

15. The apparatus of claim 10, wherein fusing the current position estimate with the previous position estimate comprises:
computing a fusion weight based on a sigmoid function evaluated at a product of an uncertainty value associated with the current position estimate and a time factor associated with the previous position estimate; and
combining the previous position estimate weighted by the fusion weight with the current position estimate weighted by a complement of the fusion weight.

16. A computer-readable medium storing computer executable code for operation of a user equipment (UE), comprising code to:
obtain, by the UE, a current position estimate of the UE determined based on signals received from a global navigation satellite system (GNSS);
determine, by the UE, a current movement status of the UE; and
when the current movement status indicates that the UE is stationary:
fuse the current position estimate with a previous position estimate to generate a fused position estimate; and
output the fused position estimate as positioning data of the UE.

17. The computer-readable medium of claim 16, wherein determining the current movement status of the UE comprises:
collecting, by the UE, base station signal measurements; and
processing the base station signal measurements using an artificial intelligence (AI) model to determine the current movement status.

18. The computer-readable medium of claim 17, wherein the AI model comprises a neural network.

19. The computer-readable medium of claim 17, wherein the base station signal measurements comprise at least one of:
reference signal received power (RSRP);
reference signal received quality (RSRQ);
signal-to-interference-plus-noise ratio (SINR);
received signal strength indicator (RSSI);
serving cell change times;
frequency scan results; and
time advance measurements.

20. The computer-readable medium of claim 17, further comprising code to:
feed back the positioning data to the AI model to fine-tune the AI model.
